(19) United States
(12) Patent Application Publication
(10) Pub. No.: US 2022/0222121 A1
(43) Pub. Date: Jul. 14, 2022

(54) INFORMATION PROCESSING DEVICE, COMPUTER-READABLE RECORDING MEDIUM STORING PROGRAM, AND INFORMATION PROCESSING METHOD

(71) Applicant: FUJITSU LIMITED, Kawasaki-shi (JP)

(72) Inventors: HIROKI OHTSUJI, Yokohama (JP); Eiji Yoshida, Yokohama (JP)

(73) Assignee: FUJITSU LIMITED, Kawasaki-shi (JP)

(21) Appl. No.: 17/450,701

(22) Filed: Oct. 13, 2021

(30) Foreign Application Priority Data
Jan. 12, 2021 (JP) 2021-002894

(51) Int. Cl. G06F 9/50; G06F 9/30; G06F 9/54

(52) U.S. Cl. CPC G06F 9/5038; G06F 9/547; G06F 9/546; G06F 9/3009

(57) ABSTRACT

An information processing device includes: a memory; and a processor coupled to the memory and configured to: record a relation between a number of threads and latency; and alter the number of threads for each piece of processing such that a value that relates to the latency is minimized, based on a number of tasks stored in a queue and execution time.

### CROSS-REFERENCE TO RELATED APPLICATION

This application is based upon and claims the benefit of priority of the prior Japanese Patent Application No. 2021-2894, filed on Jan. 12, 2021, the entire contents of which are incorporated herein by reference.

### FIELD

The embodiment discussed herein is related to an information processing device, a program, and an information processing method.

### BACKGROUND

When handling data existing in a volatile memory or non-volatile memory on a remote node, there are a method of rewriting the data by remote memory access (remote direct memory access (RDMA)) and a method of handling the data on the remote node by remote procedure call (RPC). Note that the volatile memory may be simply referred to as a memory.

Japanese Laid-open Patent Publication No. 11-249919 and Japanese Laid-open Patent Publication No. 2019-57303 are disclosed as related art.

### SUMMARY

According to an aspect of the embodiments, An information processing device includes: a memory; and a processor coupled to the memory and configured to: record a relation between a number of threads and latency; and alter the number of threads for each piece of processing such that a value that relates to the latency is minimized, based on a number of tasks stored in a queue and execution time.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram explaining processing for a response to a client node from a server in a related example;

FIG. 2 is a diagram illustrating a first allocation example of asynchronous parallel processing as the related example;

FIG. 3 is a diagram illustrating a second allocation example of the asynchronous parallel processing as the related example;

FIG. 4 is a block diagram schematically illustrating an exemplary configuration of an information processing system as an exemplary embodiment;

FIG. 5 is a block diagram schematically illustrating an exemplary hardware configuration of a server illustrated in FIG. 4;

FIG. 6 is a diagram explaining selection processing for optimum values of the number of worker threads Nw and the number of polling threads Np in the server illustrated in FIG. 5;

FIG. 7 is a diagram explaining an allocation example of asynchronous parallel processing in the server illustrated in FIG. 5;

FIG. 8 is a flowchart explaining creation processing for maps of worker queue latency Lw and completion queue latency Lc in the server illustrated in FIG. 5;

FIG. 9 is a flowchart explaining application processing for the number of worker threads Nw and the number of polling threads Np when the maps are not updated in the server illustrated in FIG. 5; and

FIG. 10 is a flowchart explaining application processing for the number of worker threads Nw and the number of polling threads Np when the maps are updated in the server illustrated in FIG. 5.

### DESCRIPTION OF EMBODIMENTS

When using a high-speed network such as InfiniBand directly, there are three stages of asynchronous parallel processing: polling for data reception, confirmation of accepted data, and allocation to processing threads.

With the advent of the non-volatile memory, which has an overwhelmingly lower latency than a hard disk drive (HDD) and a flash memory, there is a possibility that past mechanisms are not able to bring out the performance of a device equipped with the non-volatile memory, which has a low latency.

For example, for the three-stage asynchronous parallel processing, the time to complete the processing and the performance balance between central processing unit (CPU) cores changes depending on how to parallelize, where to divide the queue, and in which thread to execute.

In one aspect, it is an object to shorten the request response time.

### [A] Example

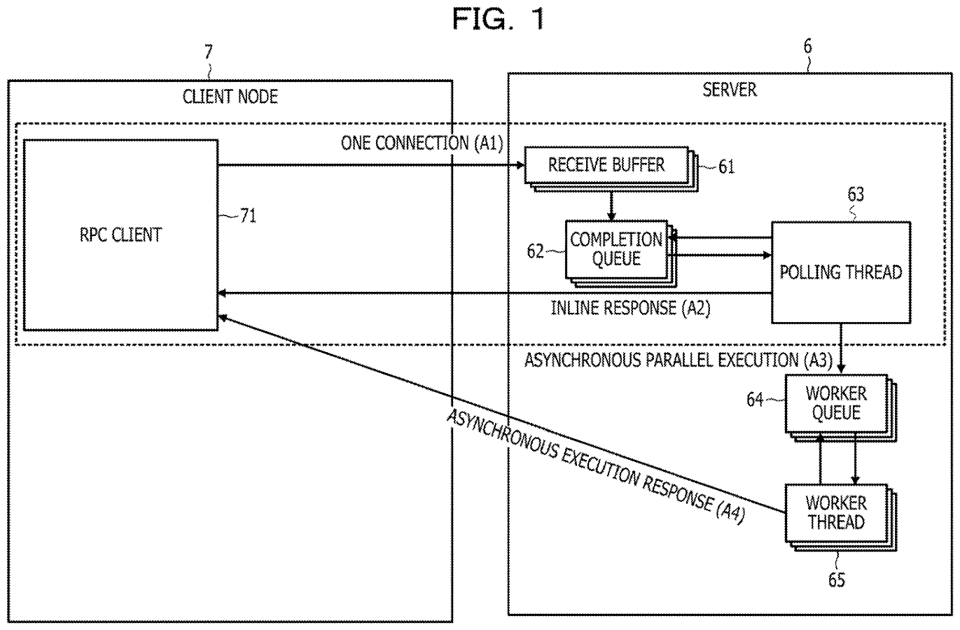

FIG. 1 is a diagram explaining processing for a response to a client node 7 from a server 6 in a related example.

As indicated by the reference sign A1, the client node 7 establishes one connection to the server 6 by an RPC client 71.

When a receive buffer 61 receives data in the server 6, the received information is input to a completion queue 62. Then, as indicated by the reference sign A2, a polling thread 63 executes an inline response to the client node 7 when the response time is prioritized.

The completion queue 62 is a queue for knowing the completion of data reception, and a network device 15 adds an entry when the reception is completed. The polling thread 63 polls the completion queue 62 in a busy loop and analyzes the received data by confirming, for example, the type of RPC, if there is an entry, to perform inline execution or asynchronous execution by adding the entry to a worker queue 64.

On the other hand, as indicated by the reference sign A3, when the response time is not prioritized, the polling thread 63 adds the entry to the worker queue 64 and executes asynchronous parallel processing.

The worker queue 64 is where the polling thread 63 adds a work entry (in other words, a task).

As indicated by the reference sign A4, a worker thread 65 fetches the entry from the worker queue 64 and makes an asynchronous execution response to the client node 7.

The worker thread 65 polls the worker queue 64 and acquires an entry, if there is any entry, to execute processing according to the contents.

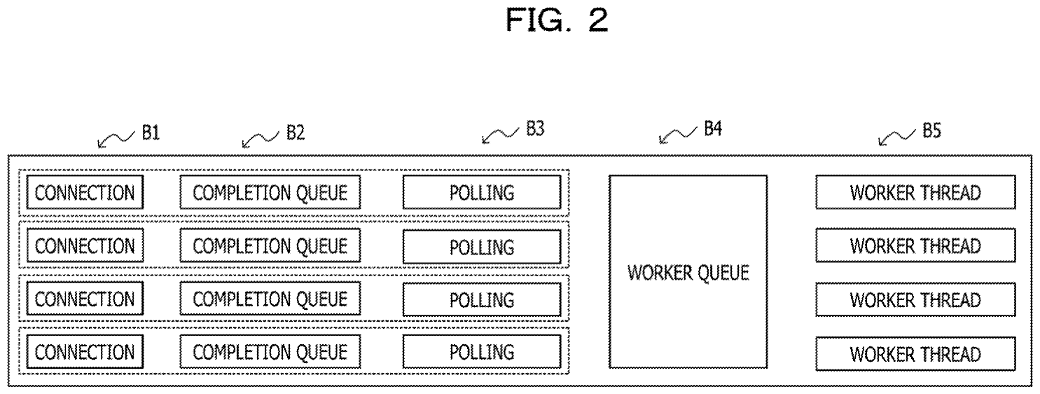

FIG. 2 is a diagram illustrating a first allocation example of the asynchronous parallel processing as the related example.

In the example illustrated in FIG. 2, as indicated by the reference signs B1 to B3, four sets of “connection”, “completion queue”, and “polling” processing are executed in parallel. Then, the results of the four sets of processing are collectively input to “worker queue” as indicated by the reference sign B4, and the processing results of “worker queue” are separately input to four “worker threads” as indicated by the reference sign B5.

As illustrated in FIG. 2, if the polling thread 63 is prepared for each connection, the time until the received data is arranged is made shorter, but when the number of connections is expanded or the load is raised, it takes time to consume the worker queue 64, and there is a possibility that the response time is extended.

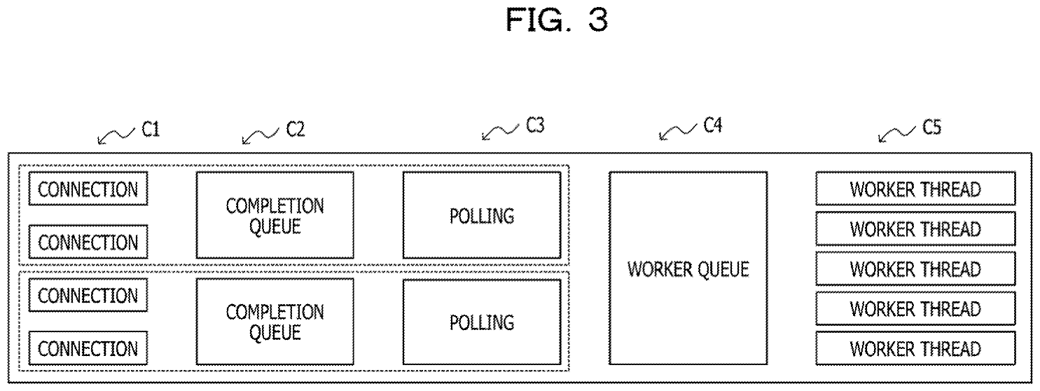

FIG. 3 is a diagram illustrating a second allocation example of the asynchronous parallel processing as the related example.

In the example illustrated in FIG. 3, as indicated by the reference signs C1 to C3, two sets of “connection”, “completion queue”, and “polling” processing are executed in parallel. Two pieces of “connection” processing are included in each set. Then, the results of the two sets of processing are collectively input to “worker queue” as indicated by the reference sign C4, and the processing results of “worker queue” are separately input to five “worker threads” as indicated by the reference sign C5.

As illustrated in FIG. 3, when the processing in the worker queue 64 is light, there is a possibility that the processing for received messages will be rate-limiting.

In this manner, there is a possibility that the performance deteriorates unless a proper configuration is selected according to both of the load status and the response time demand of the request. For example, it is needed to dynamically alter the association between the completion queue 62, the polling thread 63, the worker queue 64, and the worker thread 65.

### [B] Embodiment

Hereinafter, an embodiment will be described with reference to the drawings. Note that the embodiment to be described below is merely an example, and there is no intention to exclude application of various modifications and techniques not explicitly described in the embodiment. For example, the present embodiment may be variously modified and implemented without departing from the gist thereof. Furthermore, each drawing is not intended to include only the constituent elements illustrated in the drawing and may include other functions and the like.

In the following, each same reference sign represents a similar part in the drawings, and thus description thereof will be omitted.

### [B-1] Exemplary Configuration

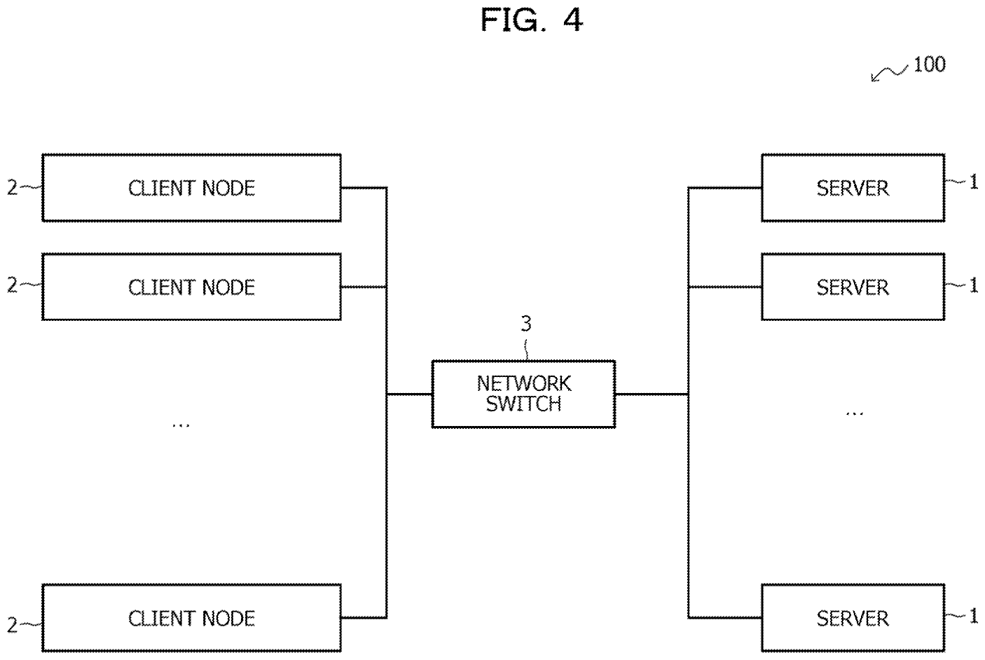

FIG. 4 is a block diagram schematically illustrating an exemplary configuration of an information processing system 100 as an exemplary embodiment.

The information processing system 100 includes a plurality of servers 1, a plurality of client nodes 2, and a network switch 3. The plurality of servers 1 and the plurality of client nodes 2 are connected via the network switch 3.

The server 1 is a computer (in other words, an information processing device) having a server function.

The client node 2 accesses the server 1 and acquires various kinds of data.

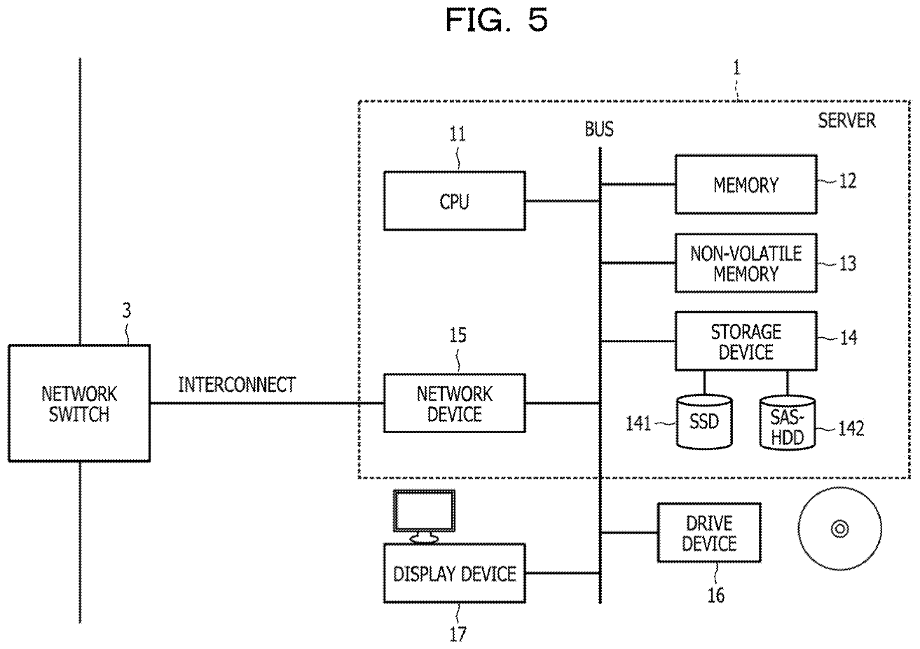

FIG. 5 is a block diagram schematically illustrating an exemplary hardware configuration of the server 1 illustrated in FIG. 4.

The server 1 may include a CPU 11, a memory 12, a non-volatile memory 13, a storage device 14, and a network device 15. Furthermore, the server 1 may be connected to a drive device 16 and a display device 17. Note that the client node 2 may also have a hardware configuration similar to the hardware configuration of the server 1.

The memory 12 is, for example, a storage device including a read only memory (ROM) and a random access memory (RAM). The RAM may be, for example, a dynamic RAM (DRAM). In the ROM of the memory 12, programs such as a basic input/output system (BIOS) may be written. A software program in the memory 12 may be appropriately read and executed by the CPU 11. Furthermore, the RAM of the memory 12 may be used as a primary recording memory or a working memory.

The non-volatile memory 13 has a higher access speed than the access speed of the storage device 14 and may be used as a secondary recording memory.

The storage device 14 is connected to, for example, a solid state drive (SSD) 141 and a serial attached small computer system interface (SCSI)-hard disk drive (SAS-HDD) 142.

The network device 15 is connected to the network switch 3 via an interconnect.

The drive device 16 is configured such that a recording medium is attachable to the drive device 16. The drive device 16 is configured such that information recorded in a recording medium is readable in a state in which the recording medium is attached to the drive device 16. In the present example, the recording medium is portable. For example, the recording medium is a flexible disk, an optical disk, a magnetic disk, a magneto-optical disk, a semiconductor memory, or the like.

The display device 17 is a liquid crystal display, an organic light-emitting diode (OLED) display, a cathode ray tube (CRT), an electronic paper display, or the like and displays various sorts of information for an operator or the like.

The CPU 11 is a processing device that performs various kinds of control and computation and achieves various functions by executing an operating system (OS) and programs stored in the memory 12.

Note that a program for achieving the functions as the CPU 11 is provided, for example, in the form of being recorded on the recording medium described above. Then, the computer reads the program from that recording medium via the drive device 16, transfers the program to an internal storage device or an external storage device, and stores the program therein to use. Furthermore, for example, this program may be recorded in a storage device (recording medium) such as a magnetic disk, an optical disk, or a magneto-optical disk and provided from the storage device to the computer via a communication path.

At the time of achieving the functions as the CPU 11, the program stored in the internal storage device (the memory 12 in the present embodiment) is executed by a microprocessor (the CPU 11 in the present embodiment) of the computer. At this time, the computer may read and execute the program recorded in the recording medium.

The CPU 11 controls, for example, the operation of the entire server 1. The device for controlling the operation of the entire server 1 is not limited to the CPU 11 and may be any one of an MPU, DSP, ASIC, PLD, and FPGA, for example. Furthermore, the device for controlling the operation of the entire server 1 may be a combination of two or more types of the CPU, MPU, DSP, ASIC, PLD, and FPGA. Note that the MPU is an abbreviation for a micro processing unit, the DSP is an abbreviation for a digital signal processor, and the ASIC is an abbreviation for an application specific integrated circuit. Furthermore, the PLD is an abbreviation for a programmable logic device, and the FPGA is an abbreviation for a field programmable gate array.

The server 1 records a relationship between the number of worker threads Nw and a worker thread utilization rate W and worker queue latency Lw, and a relationship between the number of polling threads Np and a polling thread utilization rate P and completion queue latency Lc. These relationships may be referred to as maps and change depending on the application due to the influence of processing granularity, request intervals, and variations in task size.

Note that the worker thread utilization rate W indicates the ratio of the worker processing time to the CPU time of a core for the worker. The worker queue latency Lw indicates the time from when a work entry is added to the worker queue to when the processing is completed by the worker. The polling thread utilization rate P indicates the ratio of the received data processing time to the CPU time of a core for polling. The completion queue latency Lc indicates the time from when data is received to when the data is processed and added to the worker queue. Furthermore, in the case of inline processing, the completion queue latency Lc indicates the time until the actual processing is completed, instead of the addition to the worker queue.

A tuning mode may be prepared in the system. In the tuning mode, the number of worker threads Nw and the number of polling threads Np are automatically altered within a certain range, and maps are created. The tuning mode may be used at the time of system boot or test run.

During system administration, the number of worker threads Nw and the number of polling threads Np that minimize the sum of the worker queue latency Lw and the completion queue latency Lc are designated by the maps. In a case where the completion queue latency Lc can be made still shorter within a range where the worker queue latency Lw is not degraded, the number of polling threads Np may be extended by using a setting for such a case. This allows the latency at the time of inline response to be made shorter as much as possible.

The reasons for controlling the number of worker threads Nw, the number of polling threads Np, the worker queue latency Lw, and the completion queue latency Lc through the worker thread utilization rate W and the polling thread utilization rate P will be described below.

Regardless of the received data, it is expected to take time for data examination and queue creation processing. On the other hand, as for the processing in the worker, the load is not fixed, and very heavy processing and light processing are likely to be mixed.

For example, when a large number of pieces of light processing are input, the polling thread utilization rate P increases, while the worker thread utilization rate W is rate-limited by the processing of the received data and is not raised. In such a case, the completion queue latency Lc becomes long, while the worker queue latency Lw can be kept in a short state even if the number of worker threads Nw is not so large. For example, the number of worker threads Nw needs to be reduced, and the number of polling threads Np needs to be extended.

Furthermore, when a large number of pieces of heavy processing are input, the polling thread utilization rate P decreases, while the worker thread utilization rate W increases.

In order to deal with such an imbalance, the number of worker threads Nw, the number of polling threads Np, the worker queue latency Lw, and the completion queue latency Lc are controlled through the worker thread utilization rate W and the polling thread utilization rate P.

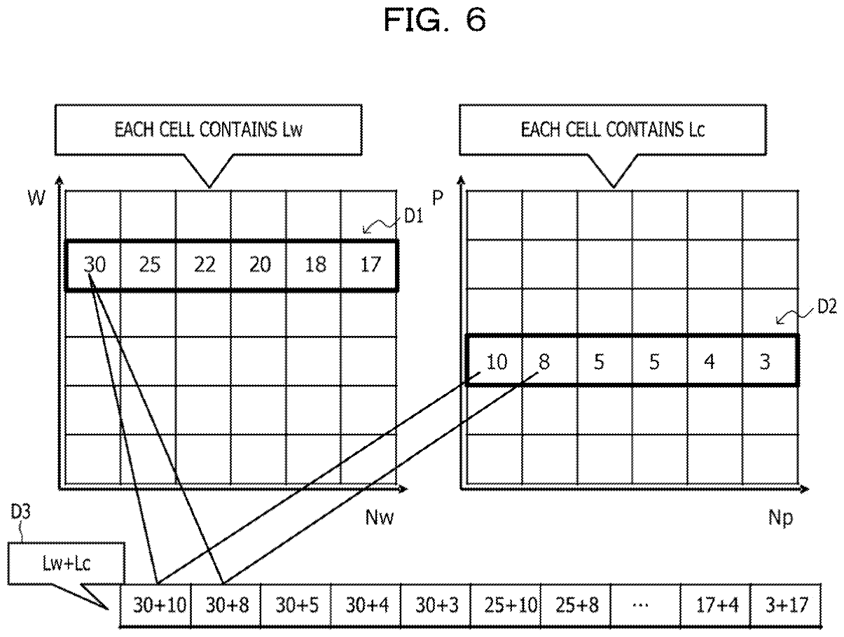

FIG. 6 is a diagram explaining selection processing for optimum values of the number of worker threads Nw and the number of polling threads Np in the server 1 illustrated in FIG. 5.

There is a constraint that the total of the number of worker threads Nw and the number of polling threads Np is not allowed to exceed the number of equipped CPU cores (or the number of cores permitted to be used). For combinations of the number of worker threads Nw and the number of polling threads Np within the range that satisfies the constraint, the sum Lw+Lc of the worker queue latency Lw and the completion queue latency Lc is calculated from the current worker thread utilization rate W and polling thread utilization rate P.

As indicated by the reference sign D1, in the map of the number of worker threads Nw and the worker thread utilization rate W, each cell contains the worker queue latency Lw, and worker queue latencies Lw within the range that satisfies the constraint, which are indicated in the thick line frame, are selected.

Furthermore, as indicated by the reference sign D2, in the map of the number of polling threads Np and the polling thread utilization rate P, each cell contains the completion queue latency Lc, and completion queue latencies Lc within the range that satisfies the constraint, which are indicated in the thick line frame, are selected.

Then, as indicated by the reference sign D3, the sum Lw+Lc of the worker queue latency Lw and the completion queue latency Lc in the range that satisfies constraint is individually calculated.

For example, the relation between the number of threads and the latency is recorded, and the number of threads for each piece of processing is altered such that a value relating to the latency is minimized, based on the number of tasks stored in the queue and the execution time. The number of threads may include the number of polling threads Np and the number of worker threads Nw. The value relating to the latency may include the sum Lw+Lc of the time from when a work entry is stored in the worker queue to when the processing is completed by the worker and the time from when data is received and processed to when the data is added to the worker queue. When there is a plurality of values that have the same sum Lw+Lc, the number of polling threads Np in the number of threads may be made greater.

At the time of system startup, a test workload is operated and the number of worker threads Nw and the number of polling threads Np are altered within the range where the number of CPU cores included in the system is not exceeded. Then, a relation map between the number of worker threads Nw and the worker queue latency Lw and a relation map between the number of polling threads Np and the completion queue latency Lc are created.

For dynamic map update, the maps are updated with the values (in other words, the measured values) of the worker queue latency Lw and the completion queue latency Lc at the latest polling thread utilization rate P, worker thread utilization rate W, number of worker threads Nw, and number of polling threads Np, during periodic processing.

In the periodic processing during system administration, the completion queue latency Lc and the worker queue latency Lw are monitored, and the polling thread utilization rate P and the worker thread utilization rate W are also monitored. Since the polling thread utilization rate P and the worker thread utilization rate W are likely to change, a search for a combination of the number of worker threads Nw and the number of polling threads Np that can further shorten Lc+Lw is made with reference to the relation maps. When a plurality of values that achieve the same Lc+Lw is found, a combination that maximizes the number of polling threads Np may be used. A combination that goes beyond a completion queue latency upper limit value Lcu and a worker queue latency upper limit value Lwu is not used even if the combination has the minimum Lc+Lw. Note that the completion queue latency upper limit value Lcu is the upper limit setting value of the completion queue processing time, and the worker queue latency upper limit value Lwu is the upper limit setting value of the worker latency.

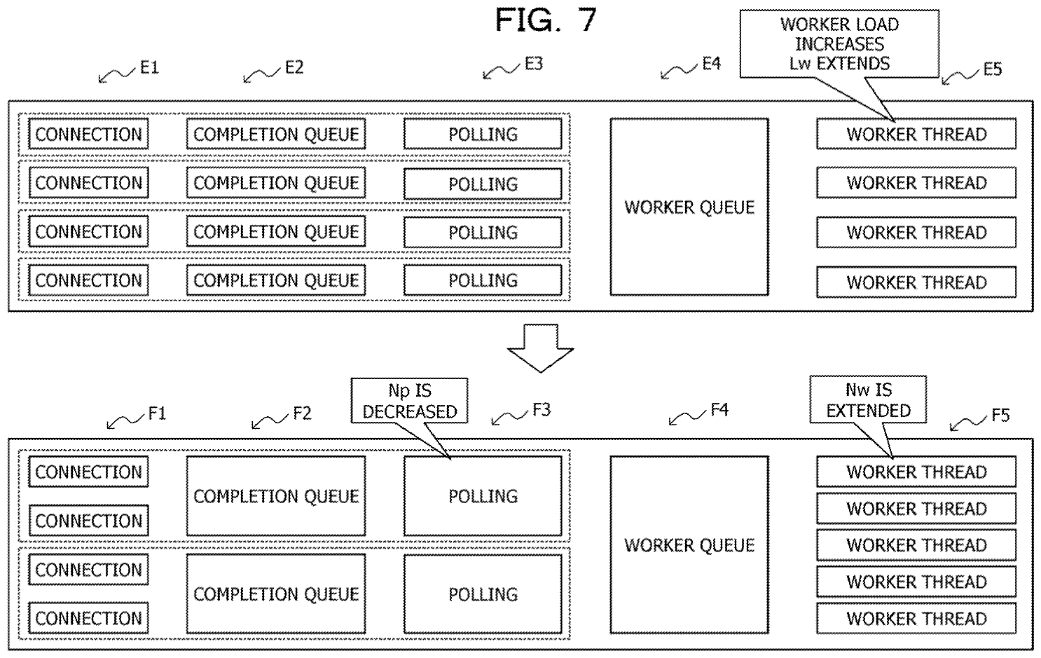

FIG. 7 is a diagram explaining an allocation example of asynchronous parallel processing in the server 1 illustrated in FIG. 5.

As indicated by the reference signs E1 to E3, four sets of “connection”, “completion queue”, and “polling” processing are executed in parallel. Then, the results of the four sets of processing are collectively input to “worker queue” as indicated by the reference sign E4, and the processing results of “worker queue” are separately input to four “worker threads” as indicated by the reference sign E5.

This increases the load on “worker thread” and extends the worker queue latency Lw.

Thus, as indicated by the reference signs F1 to F3, two sets of “connection”, “completion queue”, and “polling” processing are executed in parallel. Two pieces of “connection” processing are included in each set. Then, the results of the two sets of processing are collectively input to “worker queue” as indicated by the reference sign F4, and the processing results of “worker queue” are separately input to five “worker threads” as indicated by the reference sign F5.

This means that the number of polling threads Np is decreased, and the number of worker threads Nw is extended.

### [B-2] Operation Example

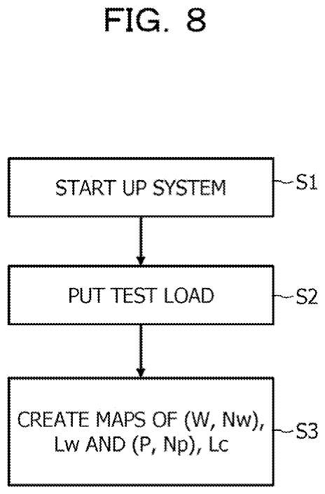

Creation processing for the maps of the worker queue latency Lw and the completion queue latency Lc in the server 1 illustrated in FIG. 5 will be described with reference to the flowchart illustrated in FIG. 8 (steps S1 to S3).

The system is started up (step S1).

A test load is put into the system (step S2).

A map of the number of worker threads Nw and the worker thread utilization rate W and the worker queue latency Lw, and a map of the number of polling threads Np and the polling thread utilization rate P and the completion queue latency Lc are created (step S3). Then, the creation processing for the maps of the worker queue latency Lw and the completion queue latency Lc ends.

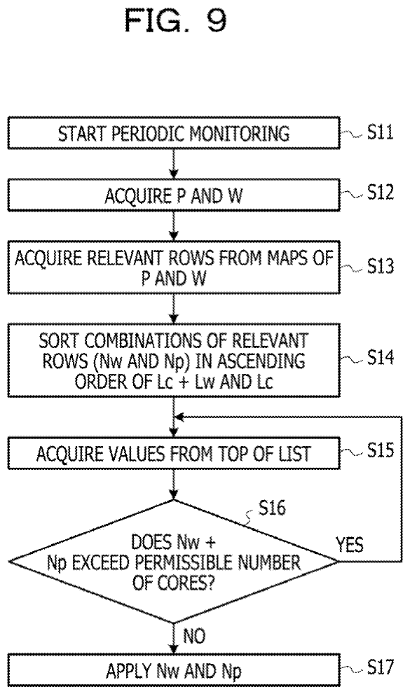

Next, application processing for the number of worker threads Nw and the number of polling threads Np when the maps are not updated in the server 1 illustrated in FIG. 5 will be described with reference to the flowchart illustrated in FIG. 9 (steps S11 to S17).

Periodic monitoring is started (step S11).

The polling thread utilization rate P and the worker thread utilization rate W are acquired (step S12).

The relevant rows in the maps of the polling thread utilization rate P and the worker thread utilization rate W are acquired (step S13).

Combinations of the relevant rows (Nw and Np) are sorted in ascending order of Lc+Lw and Lc (step S14).

The values are acquired in order from the top of the sorted list (step S15).

It is determined whether Nw+Np exceeds a permissible number of cores (step S16).

When Nw+Np exceeds the permissible number of cores (refer to the YES route in step S16), the processing returns to step S15.

On the other hand, when Nw+Np does not exceed the permissible number of cores (refer to the NO route in step S16), the acquired number of worker threads Nw and number of polling threads Np are applied (step S17). Then, the application processing for the number of worker threads Nw and the number of polling threads Np when the maps are not updated ends.

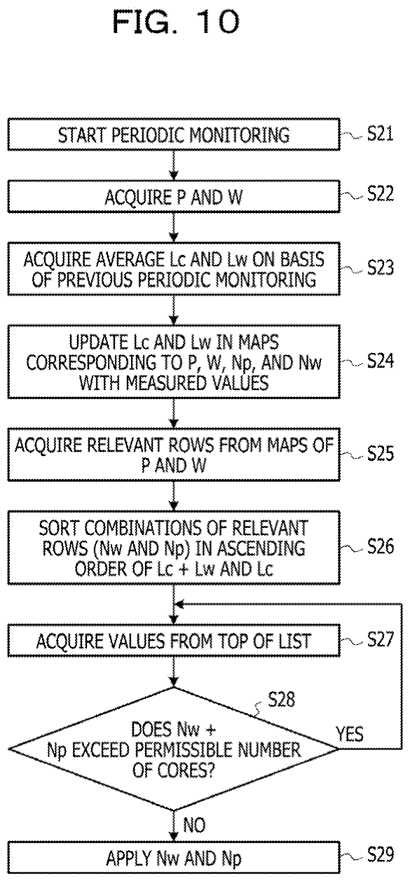

Next, application processing for the number of worker threads Nw and the number of polling threads Np when the maps are updated in the server 1 illustrated in FIG. 5 will be described with reference to the flowchart illustrated in FIG. 10 (steps S21 to S29).

Periodic monitoring is started (step S21).

The polling thread utilization rate P and the worker thread utilization rate W are acquired (step S22).

The average completion queue latency Lc and worker queue latency Lw are acquired on the basis of the results of the previous periodic monitoring (step S23).

A completion queue latency Lc and a worker queue latency Lw in the maps corresponding to the polling thread utilization rate P, the worker thread utilization rate W, the number of polling threads Np, and the number of worker threads Nw are updated with the measured values (step S24).

The relevant rows in the maps of the polling thread utilization rate P and the worker thread utilization rate W are acquired (step S25).

Combinations of the relevant rows (Nw and Np) are sorted in ascending order of Lc+Lw and Lc (step S26).

The values are acquired in order from the top of the sorted list (step S27).

It is determined whether Nw+Np exceeds a permissible number of cores (step S28).

When Nw+Np exceeds the permissible number of cores (refer to the YES route in step S28), the processing returns to step S27.

On the other hand, when Nw+Np does not exceed the permissible number of cores (refer to the NO route in step S28), the acquired number of worker threads Nw and number of polling threads Np are applied (step S29). Then, the application processing for the number of worker threads Nw and the number of polling threads Np when the maps are updated ends.

### [B-3] Effects

The information processing device, the program, and the information processing method according to the exemplary embodiment described above may exert the following actions and effects, for example.

The relation between the number of threads and the latency is recorded, and the number of threads for each piece of processing is altered such that a value relating to the latency is minimized, based on the number of tasks stored in the queue and the execution time. This allows to shorten the request response time. For example, under the condition of a constraint number of threads (in other words, a constraint number of cores), the total response time of communication and processing may be dynamically shortened according to the situation. Furthermore, even with the same processing load, the inline response time may be made shorter.

The number of threads includes the number of polling threads Np and the number of worker threads Nw. This allows to properly designate the number of polling threads Np and the number of worker threads Nw.

The value relating to the latency includes the sum Lw+Lc of the time from when a work entry is stored in the worker queue to when the processing is completed by the worker and the time from when data is received and processed to when the data is added to the worker queue. This allows a setting value that is able to make the completion queue latency Lc still shorter within a range where the worker queue latency Lw is not degraded to be used in such a case and the latency at the time of inline response to be made shorter as much as possible.

When there is a plurality of values that have the same sum Lw +Lc, the number of polling threads Np in the number of threads is made greater. This allows the completion queue latency Lc to be made shorter.

### [C] Others

The disclosed technique is not limited to the embodiment described above and may be variously modified and implemented without departing from the gist of the present embodiment. Each of the configurations and processing according to the present embodiment may be selected as needed or may be combined as appropriate.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing device comprising:
a memory; and
a processor coupled to the memory and configured to:
record a relation between a number of threads and latency; and
alter the number of threads for each piece of processing such that a value that relates to the latency is minimized, based on a number of tasks stored in a queue and execution time.

2. The information processing device according to claim 1, wherein the number of threads includes a number of polling threads and a number of worker threads.

3. The information processing device according to claim 1, wherein the value that relates to the latency includes a sum of a time from when a work entry is stored in a worker queue to when processing is completed by a worker and a time from when data is received and processed to when the data is added to the worker queue.

4. The information processing device according to claim 3, wherein
the processor makes the number of polling threads in the number of threads greater when there is a plurality of values that each have the sum that is same.

5. A non-transitory computer-readable recording medium storing a program causing a computer to execute a processing, the processing comprising:
recording a relation between a number of threads and latency; and
altering the number of threads for each piece of processing such that a value that relates to the latency is minimized, based on a number of tasks stored in a queue and execution time.

6. The non-transitory computer-readable recording medium according to claim 5, wherein the number of threads includes a number of polling threads and a number of worker threads.

7. The non-transitory computer-readable recording medium according to claim 5, wherein the value that relates to the latency includes a sum of a time from when a work entry is stored in a worker queue to when processing is completed by a worker and a time from when data is received and processed to when the data is added to the worker queue.

8. The non-transitory computer-readable recording medium according to claim 7, further comprising:
making the number of polling threads in the number of threads greater when there is a plurality of values that each have the sum that is same.

9. An information processing method comprising:
recording, by a computer, a relation between a number of threads and latency; and
altering the number of threads for each piece of processing such that a value that relates to the latency is minimized, based on a number of tasks stored in a queue and execution time.

10. The information processing method according to claim 9, wherein the number of threads includes a number of polling threads and a number of worker threads.

11. The information processing method according to claim 9, wherein the value that relates to the latency includes a sum of a time from when a work entry is stored in a worker queue to when processing is completed by a worker and a time from when data is received and processed to when the data is added to the worker queue.

12. The information processing method according to claim 11, further comprising:
making the number of polling threads in the number of threads greater when there is a plurality of values that each have the sum that is same.
